(19) United States
(12) Patent Application Publication
(10) Pub. No.: US 2023/0178723 A1
(43) Pub. Date: Jun. 8, 2023

(54) POSITIVE ELECTRODE FOR NON-AQUEOUS ELECTROLYTE SECONDARY BATTERY, AND NON-AQUEOUS ELECTROLYTE SECONDARY BATTERY, BATTERY MODULE AND BATTERY SYSTEM USING THE SAME

(71) Applicant: SEKISUI CHEMICAL CO., LTD., Osaka (JP)

(72) Inventors: Yuichi SABI, Tsukuba-shi (JP); Hikaru YOSHIKAWA, Tsukuba-shi (JP)

(73) Assignee: SEKISUI CHEMICAL CO., LTD., Osaka (JP)

(21) Appl. No.: 17/768,958

(22) PCT Filed: Mar. 18, 2022
(86) PCT No.: PCT/JP2022/012820

§ 371 Date: Apr. 14, 2022

(30) Foreign Application Priority Data
Mar. 19, 2021 (JP) 2021-045981

(51) Int. Cl. H01M 4/525; H01M 4/62

(52) U.S. Cl. CPC H01M 4/525; H01M 4/625; H01M 2004/028

(57) ABSTRACT

A positive electrode (1) for a non-aqueous electrolyte secondary battery, including a current collector (11) and an active material layer (12) provided on the current collector (11), wherein: the active material layer (12) includes one or more positive electrode active material particles; and a true density D of the active material and a true density D1 of the active material layer (12) satisfy 0.96≤D1<D. The positive electrode active material preferably includes a compound represented by a formula LiFeₓM₍₁₋ₓ₎PO₄, wherein 0≤x≤1, M is Co, Ni, Mn, Al, Ti or Zr.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2021-045981, filed Mar. 19, 2021, the contents of which are incorporated herein by reference.

### BACKGROUND ART

A non-aqueous electrolyte secondary battery is generally composed of a positive electrode, a non-aqueous electrolyte, a negative electrode, and a separation membrane (separator) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil (current collector).

Examples of the practically used positive electrode active material containing lithium ions include lithium transition metal composite oxides such as lithium cobalt oxide (LiCoO₂), lithium nickel oxide (LiNiO₂), and lithium manganese oxide (LiMn₂O₄), and lithium phosphate compounds such as lithium iron phosphate (LiFePO₄).

PLT 1 describe a positive electrode in which a positive electrode active material layer composed of a lithium phosphate compound, a binder and a conducting agent, is provided on an aluminum foil. PTL 1 describes an example where the positive electrode active material layer is prepared so as to have specific proportions of pores attributable to primary particles of the lithium phosphate compound and the pores attributable to the secondary particles of the lithium phosphate compound, and have a porosity within a specific range, to thereby improve the cycling performance.

Among the lithium phosphate compounds, lithium iron phosphate has a high electric resistance and, hence, the performance improvement by lowering its resistance is required.

NPL 1 reports that the battery capacity is improved by coating the surface of the iron phosphate active material with carbon.

### CITATION LIST

### Patent Literature

PTL 1: Japanese Patent Application Unexamined Publication No. 2014-13748

### Non Patent Literature

NPL 1: I. Belharouak, C. Johnson, K. Amine, Synthesis and electrochemical analysis of vapor-deposited carbon-coated LiFePO4, Electrochemistry Communications, Volume 7, Issue 10, October 2005, Pages 983-988

### SUMMARY OF INVENTION

### Technical Problem

However, these methods are not necessarily satisfactory, and further improvement of battery performance is required.

The present invention provides a positive electrode for a non-aqueous electrolyte secondary battery, which can improve the high-rate cycling performance of a non-aqueous electrolyte secondary battery.

### Solution to Problem

The embodiments of the present invention are as follows.

<1> A positive electrode for a non-aqueous electrolyte secondary battery, including a positive electrode current collector and a positive electrode active material layer provided on the positive electrode current collector, wherein:

the positive electrode active material layer comprises one or more positive electrode active material particles comprising a positive electrode active material; and

a true density D of the positive electrode active material and a true density D1 of the positive electrode active material layer satisfy formula (s), and D1/D is preferably 0.97 to 0.99, more preferably 0.98 to 0.99:

0.96D≤D1<D (s).

<2> The positive electrode active material according to <1>, wherein the positive electrode active material includes a compound represented by a formula LiFeₓM₍₁₋ₓ₎PO₄, wherein 0≤x≤1, M is Co, Ni, Mn, Al, Ti or Zr.

<3> The positive electrode according to <2>, wherein the positive electrode active material is lithium iron phosphate represented by LiFePO₄.

<4> The positive electrode according to <3>, wherein the true density D1 is 3.4 g/cm³ or more and less than 3.6 g/cm³, preferably 3.4 to 3.55 g/cm³, more preferably 3.4 to 3.50 g/cm³.

<5> The positive electrode according to any one of <1> to <4>, wherein the positive electrode active material layer further includes a conducting agent and a binder, wherein the conducting agent is preferably at least one carbon material selected from the group consisting of graphite, graphene, hard carbon, Ketjen black, acetylene black, and carbon nanotube (CNT), and the binder is preferably at least one organic compound selected from the group consisting of polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide, with the proviso that an amount of the conducting agent in the positive electrode active material layer is preferably 0.5% by mass or less, more preferably 0.2% by mass or less, based on the total mass of the positive electrode active material layer, and an amount of the binder is 1% by mass or less, more preferably 0.5% by mass or less, based on the total mass of the positive electrode active material layer.

<6> The positive electrode according to any one of <1> to <4>, wherein the positive electrode active material layer does not contain a conducting agent.

<7> The positive electrode according to any one of <1> to <6>, wherein at least a part of the positive electrode active material particles have a core section formed of the positive electrode active material, and a coated section which covers the core section and includes a conductive material, with the proviso that an amount of the conductive material is 1.3% by mass or less, based on the total mass of the positive electrode active material particles.

<8> The positive electrode according to any one of <1> to <7>, which has a cycle capacity retention of 80% or more, preferably 85% or more, more preferably 90% or more, even more preferably 100%, as measured by a test method including: producing a non-aqueous electrolyte secondary battery using the positive electrode so as to have a rated capacity of 1 Ah; subjecting the battery to 1000 repetitions of a charge/discharge cycle of charging at 3 C rate and 8 V, a 10-second pause, discharging at 3 C rate and 2.0 V, and a 10-second pause; discharging the battery at 0.2 C rate and 2.5 V to measure a discharge capacity B; and dividing the discharge capacity B by a discharge capacity A of the battery before being subjected to the charge/discharge cycle to determine the cycle capacity retention (%).

<9> A non-aqueous electrolyte secondary battery, including the positive electrode of any one of <1> to <8>, a negative electrode, and a non-aqueous electrolyte disposed between the positive electrode and the negative electrode.

<10> A battery module or battery system including a plurality of the non-aqueous electrolyte secondary batteries of <9>.

### Advantageous Effects of Invention

The positive electrode of the present invention can improve the high-rate cycling performance of a non-aqueous electrolyte secondary battery.

### BRIEF DESCRIPTION OF DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

### DESCRIPTION OF EMBODIMENTS

In the present specification and claims, “to” indicating a numerical range means that the numerical values described before and after “to” are included as the lower limit and the upper limit of the range.

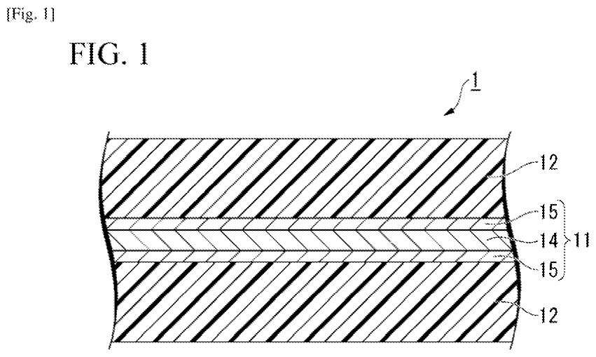

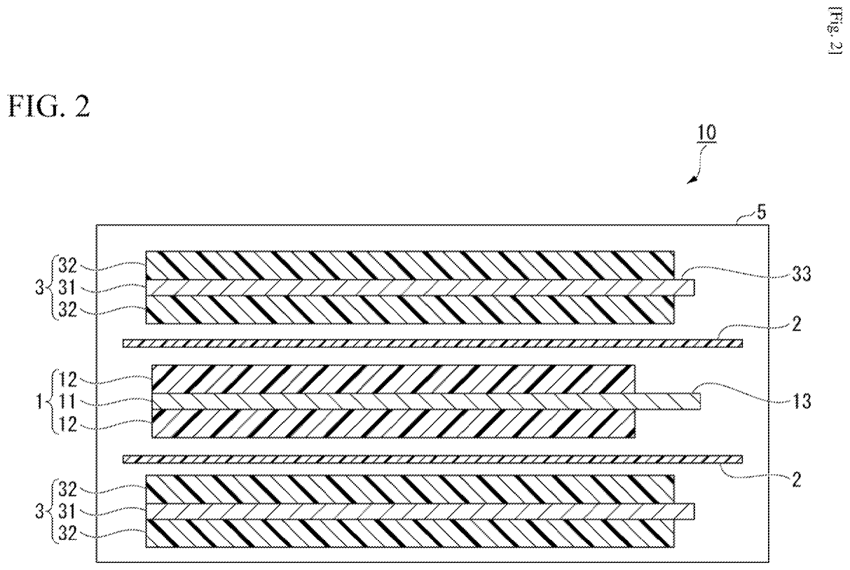

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

<Positive Electrode for Non-Aqueous Electrolyte Secondary Battery>

In the present embodiment, the positive electrode for a non-aqueous electrolyte secondary battery (also simply referred to as “positive electrode”) 1 has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has a positive electrode current collector main body 14 and current collector coating layers 15 that cover the positive electrode current collector main body 14 on its surfaces facing the positive electrode active material layers 12. The positive electrode current collector main body 14 alone may be used as the positive electrode current collector 11.

(Positive Electrode Active Material Layer)

The positive electrode active material layer 12 includes one or more positive electrode active material particles. The positive electrode active material layer 12 may further include a binder. The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material.

The positive electrode active material particles include a positive electrode active material. The positive electrode active material particles may be particles composed of only the positive electrode active material, or may have a core section composed of only the positive electrode active material, and a coating section covering the core section (particles having such a coating section are hereinafter also referred to as “coated particles”). It is preferable that at least a part of the positive electrode active material particles contained in the positive electrode active material layer 12 are coated particles.

The amount of the positive electrode active material particles is preferably 80.0 to 99.9% by mass, and more preferably 90 to 99.5% by mass, based on the total mass of the positive electrode active material layer 12.

In the positive electrode active material particles, the positive electrode active material has, on at least a part of its surface, a coating section comprising a conductive material. It is more preferable that the entire surfaces of the positive electrode active material particles are coated with a conductive material for achieving more excellent battery capacity and cycling performance.

In this context, the expression “at least a part of its surface” means that the coating section of the active material particles covers 50% or more, preferably 70% or more, more preferably 90% or more, particularly preferably 100% of the total area of the entire outer surfaces of the positive electrode active material particles. This ratio (%) of the coating section (hereinafter, also referred to as “coverage”) is an average value for all the positive electrode active material particles present in the positive electrode active material layer. As long as this average value is not less than the above lower limit value, the positive electrode active material layer may contain a small amount of positive electrode active material particles without the coating section. When the positive electrode active material particles without the coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image. The elemental analysis is performed on carbon to identify the carbon covering the positive electrode active material particles. A section with a carbon coating having a thickness of 1 nm or more is defined as the coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the coating section of the active material is a layer directly formed on the surface of particles (core section) composed of only the positive electrode active material, which has a thickness of 1 nm to 100 nm, preferably 5 nm to 50 nm. This thickness can be determined by the above-mentioned TEM-EDX used for the measurement of the coverage.

For example, the coating section of the active material is formed in advance on the surface of the positive electrode active material particles, and is present on the surface of the positive electrode active material particles in the positive electrode active material layer. That is, the coating section of the active material in the present embodiment is not one newly formed in the steps following the preparation step of a positive electrode composition. In addition, the coating section of the active material is not one that comes off in the steps following the preparation step of a positive electrode composition.

For example, the coating section stays on the surface of the positive electrode active material even when the coated particles are mixed with a solvent by a mixer or the like during the preparation of a positive electrode composition. Further, the coating section stays on the surface of the positive electrode active material even when the positive electrode active material layer is detached from the positive electrode and then put into a solvent to dissolve the binder contained in the positive electrode active material layer in the solvent. Furthermore, the coating section stays on the surface of the positive electrode active material even when an operation to disintegrate agglomerated particles is implemented for measuring the particle size distribution of the particles in the positive electrode active material layer by the laser diffraction scattering method.

Examples of the method for producing the coated particles include a sintering method and a vapor deposition method.

Examples of the sintering method include a method that sinters an active material composition (for example, a slurry) containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, saccharides (e.g., sucrose, glucose and lactose), carboxylic acids (e.g., malic acid and citric acid), unsaturated monohydric alcohols (e.g., allyl alcohol and propargyl alcohol), ascorbic acid, and polyvinyl alcohol. This sintering method sinters an active material composition to allow carbon in the organic material to be fused to the surface of the positive electrode active material to thereby form the coated section of the active material.

Another example of the sintering method is the so-called impact sintering coating method.

The impact sintering coating method is, for example, carried our as follows. In an impact sintering coating device, a burner is ignited using a mixed gas of a hydrocarbon and oxygen as a fuel to burn the mixed gas in a combustion chamber, thereby generating a flame, wherein the amount of oxygen is adjusted so as not to exceed its equivalent amount that allows complete combustion of the fuel, to thereby lower the flame temperature. A powder supply nozzle is installed downstream thereof, from which a solid-liquid-gas three-phase mixture containing a combustion gas as well as a slurry formed by dissolving an organic substance for coating in a solvent is injected toward the flame. The injected fine powder is accelerated at a temperature not higher than the transformation temperature, the sublimation temperature, and the evaporation temperature of the powder material by increasing the amount of combustion gas maintained at room temperature to lower the temperature of the injected fine powder. This allows the particles of the powder to be instantly fused on the active material by impact, thereby forming coated particles of the positive electrode active material.

Examples of the vapor deposition method include a vapor phase deposition method such as a physical vapor deposition method (PVD) and a chemical vapor deposition method (CVD), and a liquid phase deposition method such as plating.

Further, the thickness of the positive electrode active material layer (total thickness of the positive electrode active material layers in the case where the positive electrode active material layers are formed on both sides of the positive electrode current collector) is preferably 30 to 500 μm, more preferably 40 to 400 μm, particularly preferably 50 to 300 μm. When the thickness of the positive electrode active material layer is not less than the lower limit value of the above range, it is possible to provide a positive electrode that can be used for manufacturing a battery having excellent energy density per unit volume. When the thickness is not more than the upper limit value of the above range, the peel strength of the positive electrode active material layer can be improved, thereby preventing delamination of the positive electrode active material layer during charging/discharging.

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also simply referred to as “lithium iron phosphate”).

The positive electrode active material may contain other positive electrode active materials than the compound having an olivine type crystal structure.

Preferable examples of the other positive electrode active materials include a lithium transition metal composite oxide. Specific examples thereof include lithium cobalt oxide (LiCoO₂), lithium nickel oxide (LiNiO₂), lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide (LiMn₂O₄, lithium manganese cobalt oxide (LiMnCoO₄), lithium manganese chromium oxide (LiMnCrO₄), lithium vanadium nickel oxide (LiNiVO₄), nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

With respect to the other positive electrode active materials, a single type thereof may be used individually or two or more types thereof may be used in combination.

The positive electrode active material particles in the present embodiment are preferably in the form of coated particles in which at least a part of the surface of the positive electrode active material particles is coated with a conductive material. The use of the coated particles as the positive electrode active material particles enables the battery capacity and high-rate cycling performance to be further enhanced.

The conductive material of the coating section of the active material preferably contains carbon (conductive carbon). The conductive material may be composed only of carbon, or may be a conductive organic compound containing carbon and other elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the coating section of the active material is composed only of carbon.

The coated particles are preferably coated particles having a compound with an olivine crystal structure as the core section, more preferably coated particles having a compound represented by the formula (I) as the core section, and even more preferably coated particles having lithium iron phosphate as the core section (hereinbelow, also referred to as “coated lithium iron phosphate particles”). These coated particles can further enhance the battery capacity and the cycling performance.

In addition, it is particularly preferable that the entire surface of the core section of the coated particles is coated with a conductive material, that is, the coverage is 100%.

The coated particles can be produced by a known method. A method for producing the coated particles is described below by taking the coated lithium iron phosphate particles as an example.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder.

Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the crushing time in the crushing process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The amount of the coated particles is preferably 50% by mass or more, more preferably 80% by mass or more, even more preferably 90% by mass or more, and may be 100% by mass, based on the total mass of the positive electrode active material particles.

The amount of the compound having an olivine type crystal structure is preferably 50% by mass or more, preferably 80% by mass or more, even more preferably 90% by mass or more, and may be 100% by mass, based on the total mass of the positive electrode active material particles.

When the coated lithium iron phosphate particles are used, the amount of the coated lithium iron phosphate particles is preferably 50% by mass or more, more preferably 80% by mass or more, even more preferably 90% by mass or more, and may be 100% by mass, based on the total mass of the positive electrode active material particles.

The amount of the positive electrode active material particles is preferably 90% by mass or more, more preferably 95% by mass or more, even more preferably more than 99% by mass, particularly preferably 99.5% by mass or more, and may be 100% by mass, based on the total mass of the positive electrode active material layer 12. When the amount of the positive electrode active material particles is not less than the above lower limit, the battery capacity and the cycling performance can be further enhanced.

The average particle size of the positive electrode active material particles (that is, positive electrode active material powder) is, for example, preferably 0.1 to 20.0 μm, and more preferably 0.2 to 10.0 μm. When two or more types of positive electrode active materials are used, the average particle size of each of such positive electrode active materials may be within the above range.

The average particle size of the positive electrode active material in the present specification is a volume-based median particle size measured using a laser diffraction/scattering particle size distribution analyzer.

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

When the positive electrode active material layer 12 contains a binder, the amount of the binder in the positive electrode active material layer 12 is preferably 1% by mass or less, and more preferably 0.5% by mass or less, based on the total mass of the positive electrode active material layer 12. When the amount of the binder is not more than the above upper limit, the proportion of the substance that does not contribute to the conduction of lithium ions in the positive electrode active material layer 12 is reduced, and the true density of the positive electrode active material layer 12 increases. Further, the proportion of the binder covering the surface of the positive electrode 1 is reduced. As a result, the conductivity of lithium is further enhanced, and the high-rate cycling performance can be further improved.

When the positive electrode active material layer 12 contains a binder, the lower limit of the amount of the binder is preferably 0.1% by mass or more, based on the total mass of the positive electrode active material layer 12.

That is, when the positive electrode active material layer 12 contains a binder, the amount of the binder is preferably 0.1 to 1% by mass, and more preferably 0.1 to 0.5% by mass, based on the total mass of the positive electrode active material layer 12.

Examples of the conducting agent contained in the positive electrode active material layer 12 include carbon materials such as carbon black (e.g., Ketjen black, and acetylene black), graphite, graphene, hard carbon, and carbon nanotube (CNT). With respect to the conducting agent, a single type thereof may be used alone or two or more types thereof may be used in combination.

The amount of the conducting agent in the positive electrode active material layer 12 is, for example, preferably 1% by mass or less, more preferably 0.5% by mass or less, and even more preferably more than 0.2% by mass or less, based on the total mass of the positive electrode active material layer 12. It is particularly preferable that the positive electrode active material layer does not contain a conducting agent, and it is desirable that there are no isolated conducting agent particles (for example, isolated carbon particles). When the amount of the conducting agent is not more than the above upper limit, the proportion of the substance that does not contribute to the conduction of lithium ions in the positive electrode active material layer 12 is reduced, and the true density of the positive electrode active material layer 12 increases. As a result, the high-rate cycling performance can be further improved.

The “conducting agent” is a conductive material independent of the positive electrode active material, and may include a conductive material having a fibrous form (for example, carbon nanotube) as well as the isolated conducting agent particles.

The conducting agent in contact with the positive electrode active material particles in the positive electrode active material layer is not regarded as the conductive material constituting the coated section of the positive electrode active material.

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer.

That is, when the positive electrode active material layer 12 contains a conducting agent, the amount of the conducting agent is preferably more than 0.1% by mass and 1% by mass or less, more preferably more than 0.1% by mass and 0.5% by mass or less, and even more preferably more than 0.1% by mass and 0.2% by mass or less, based on the total mass of the positive electrode active material layer 12.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

When the positive electrode active material layer 12 contains one of both of a conducting agent and a binder, the amount thereof (sum of the amounts of the conducting agent and the binder when both of these are contained) is 0 to 4.0% by mass, more preferably 0 to 3.0% by mass, even more preferably 0.5 to 1.5% by mass, based on the total mass of the positive electrode active material layer.

(Positive Electrode Current Collector)

Examples of the material of the positive electrode current collector main body 14 include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

(Current Collector Coating Layer)

The current collector coating layer 15 contains a conductive material.

The conductive material in the current collector coating layer 15 preferably contains carbon (conductive carbon), and more preferably consists exclusively of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a slurry containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm.

The thickness of the current collector coating layer can be measured by a method of measuring the thickness of the coating layer in a transmission electron microscope (TEM) image or a scanning electron microscope (SEM) image of a cross section of the current collector coating layer. The thickness of the current collector coating layer need not be uniform. It is preferable that the current collector coating layer 15 having a thickness of 0.1 μm or more is present on at least a part of the surface of the positive electrode current collector main body 14, and the maximum thickness of the current collector coating layer is 4.0 μm or less.

(Method for Producing Positive Electrode)

For example, the positive electrode 1 of the present embodiment can be produced by a method in which a positive electrode composition containing a positive electrode active material, a binder and a solvent is coated on the positive electrode current collector 11, followed by drying to remove the solvent to thereby form a positive electrode active material layer 12. The positive electrode composition may contain a conducting agent.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The positive electrode active material layer 12 may include a dispersant. Examples of the dispersant include polyvinylpyrrolidone (PVP), one-shot varnish (manufactured by Toyocolor Co., Ltd.) and the like. When the positive electrode active material layer 12 contains a dispersant, the amount of the dispersant is preferably 0 to 0.2% by mass, more preferably 0 to 0.1% by mass, based on the total mass of the positive electrode active material layer 12. The positive electrode active material layer may not contain a dispersant.

When at least one of the conductive material covering the positive electrode active material and the conducting agent contains carbon, the positive electrode 1 preferably has a conductive carbon content of 0.5 to 3.5% by mass, more preferably 1.5 to 3.0% by mass, with respect to the mass of the positive electrode 1 excluding the positive electrode current collector main body 14.

When the positive electrode 1 is composed of the positive electrode current collector main body 14 and the positive electrode active material layer 12, the mass of the positive electrode 1 excluding the positive electrode current collector main body 14 is the mass of the positive electrode active material layer 12.

When the positive electrode 1 is composed of the positive electrode current collector main body 14, the current collector coating layer 15, and the positive electrode active material layer 12, the mass of the positive electrode 1 excluding the positive electrode current collector main body 14 is the sum of the mass of the current collector coating layer 15 and the mass of the positive electrode active material layer 12.

When the conductive carbon content based the total mass of the positive electrode active material layer 12 is within the above range, the battery capacity can be further improved, and a non-aqueous electrolyte secondary battery with a further improved cycle characteristics can be realized.

The amount of the conductive carbon with respect to the mass of the positive electrode 1 excluding the positive electrode current collector main body 14 can be measured by <<Method for measuring conductive carbon content>> described below with respect to a dried product (powder), as a measurement target, obtained by detaching the whole of a layer present on the positive electrode current collector main body 14, collecting the whole of substance resulting from the detached layer, and vacuum-drying the collected substance at 120° C.

The conductive carbon to be measured by the <<Method for measuring conductive carbon content>> described below includes carbon in the coated section of the positive electrode active material, carbon in the conducting agent, and carbon in the current collector coating layer 15. Carbon in the binder is not included in the conductive carbon to be measured.

As a method for obtaining the measurement target, for example, the following method can be adopted.

First, the layer (powder) present on the positive electrode current collector main body 14 is completely detached by a method in which the positive electrode 1 is punched to obtain a piece having a predetermined size, and the piece of the positive electrode current collector main body 14 is immersed in a solvent (for example, N-methylpyrrolidone) and stirred. Next, after confirming that no powder remains attached to the positive electrode current collector main body 14, the positive electrode current collector main body 14 is taken out from the solvent to obtain a suspension (slurry) containing the detached powder and the solvent. The obtained suspension is dried at 120° C. to completely volatilize the solvent to obtain the desired measurement target (powder).

When at least one of the conductive material covering the positive electrode active material and the conducting agent contains carbon (conductive carbon), the conductive carbon content is preferably 0.5 to 5.0% by mass, more preferably 1.0 to 3.5% by mass, and even more preferably 1.5 to 3.0% by mass, based on the total mass of the positive electrode active material layer 12.

The conductive carbon content based the total mass of the positive electrode active material layer 12 can be measured by <<Method for measuring conductive carbon content>> described below with respect to a dried product (powder), as a measurement target, obtained by vacuum-drying, at 120° C., the positive electrode active material layer 12 detached from the current collector.

The conductive carbon to be measured by the <<Method for measuring conductive carbon content>> described below includes carbon in the coating section covering the positive electrode active material, and carbon in the conducting agent. Carbon in the binder is not included in the conductive carbon to be measured.

When the conductive carbon content based the total mass of the positive electrode active material layer 12 is within the above range, the battery capacity can be further improved, and a non-aqueous electrolyte secondary battery with a further improved cycle characteristics can be realized.

<<Method for Measuring Conductive Carbon Content>>

(Measurement Method A)

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

M1=(w1−w2)/w1×100 (a1)

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

M2=(w1−w3)/w1×100 (a2)

(Measurement Method B)

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

(Burning Conditions)

Temperature of combustion furnace: 1150° C.

Temperature of reduction furnace: 850° C.

Helium flow rate: 200 mL/min.

Oxygen flow rate: 25 to 30 mL/min.

(Measurement Method C)

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH₂CF₂), molecular weight 64), the conductive carbon content can be calculated by the following formula from the fluoride ion (F.) content (unit: % by mass) measured by combustion ion chromatography based on the tube combustion method, the atomic weight (19) of fluorine in the monomers constituting PVDF, and the atomic weight (12) of carbon in the PVDF.

PVDF content (unit: % by mass)=fluoride ion content (unit: % by mass)×64/38

PVDF-derived carbon amount M4 (unit: % by mass)=fluoride ion content (unit: % by mass)×12/19

The presence of polyvinylidene fluoride as a binder can be verified by a method in which a sample or a liquid obtained by extracting a sample with an N,N-dimethylformamide (DMF) solvent is subjected to Fourier transform infrared spectroscopy (FT-IR) to confirm the absorption attributable to the C—F bond. Such verification can be also implemented by 19F-NMR measurement.

When the binder is identified as being other than PVDF, the carbon amount M4 attributable to the binder can be calculated by determining the amount (unit: % by mass) of the binder from the measured molecular weight, and the carbon content (unit: % by mass).

Depending on the composition of the positive electrode active material and the like, an appropriate method can be selected from [Measurement method A] to [Measurement method C] to determine the conductive carbon content, but it is preferable to determine the conductive carbon content by the [Measurement method B] in terms of versatility, etc. These methods are described in the following publications:

Toray Research Center, The TRC News No. 117 (September 2013), pp. 34-37, [Searched on Feb. 10, 2021], Internet <https://www.toray-research.co.jp/technical-info/trcnews/pdf/TRC117(34-37).pdf>

TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

<<Analytical Method for Conductive Carbon>>

The conductive carbon in the coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent. In this context, a trace amount of carbon considered to be an impurity and a trace amount of carbon unintentionally removed from the surface of the positive electrode active material during production are not judged to be the conducting agent.

Using any of these methods, it is possible to verify whether or not the conducting agent formed of carbon material is contained in the positive electrode active material layer.

(Pore Specific Surface Area and Central Pore Diameter of Positive Electrode Active Material Layer)

In the present embodiment, the pore specific surface area of the positive electrode active material layer 12 is preferably 5.0 to 10.0 m²/g, more preferably 6.0 to 9.5 m²/g, even more preferably 7.0 to 9.0 m²/g.

The central pore diameter of the positive electrode active material layer 12 in the present embodiment is preferably 0.06 to 0.150 μm, more preferably 0.06 to 0.130 μm, even more preferably 0.08 to 0.120 μm.

In the context of the present specification, the pore specific surface area and the central pore diameter of the positive electrode active material layer 12 are values measured by the mercury porosimetry. The central pore diameter is calculated as a median diameter (D50, unit: μm) in the pore diameter range of 0.003 to 1.000 μm in the pore diameter distribution.

When the pore specific surface area and the central pore diameter of the positive electrode active material layer 12 are within the respective ranges described above, excellent effect is achieved in terms of improving the high-rate cycling performance of the non-aqueous electrolyte secondary battery.

When the pore specific surface area is not more than the upper limit of the above range, the reactive surface area is small, thereby suppressing the generation of sites where side reactions between the positive electrode 1 and the electrolytic solution vigorously occur due to local current concentration on fine powders of the positive electrode active material and the conducting agent during the high-rate charge/discharge cycles. As a result, deterioration is likely to be suppressed.

When the central pore diameter is not lower than the lower limit of the above range, generation of sites with agglomeration of fine powders of the positive electrode active material and the conducting agent is suppressed. Therefore, non-uniformity of reaction hardly occurs during the high-rate charge/discharge cycles, and generation of sites where side reactions between the positive electrode 1 and the electrolytic solution vigorously occur is suppressed, whereby deterioration is likely to be suppressed.

The pore specific surface area and the central pore diameter of the positive electrode active material layer 12 can be controlled by, for example, adjusting the amount of the positive electrode active material, the particle size of the positive electrode active material, the thickness of the positive electrode active material layer 12, and the like. When the positive electrode active material layer 12 contains a conducting agent, the pore specific surface area and the central pore diameter can also be controlled by adjusting the amount of the conducting agent and the particle size of the conducting agent. The pore specific surface area and the central pore diameter are also affected by the amount of fine powder contained in the positive electrode active material and the dispersion state of the positive electrode composition during its preparation.

For example, when the particle size of the conducting agent is smaller than the particle size of the positive electrode active material, the central pore diameter can be increased by reducing the amount of the conducting agent to thereby reduce the pore surface area.

(Density of Positive Electrode Active Material Layer)

In the present embodiment, the true density D1 of the positive electrode active material layer 12 and the true density D of the positive electrode active material satisfy the formula (s) below.

0.96D≤D1<D (s)

That is, the ratio of the true density D1 to the true density D (D1/D ratio) is 0.96 or more and less than 1.

The D1/D ratio is preferably 0.97 to 0.99, more preferably 0.98 to 0.99.

When the D1/D ratio is not less than the above lower limit, the proportion of the substance contributing to lithium ion conduction in the positive electrode active material layer 12 is increased so as to allow a uniform charge/discharge reaction to proceed smoothly, whereby the high-rate cycling performance can be improved. When the D1/D ratio is less than (or not more than) the above upper limit value, the effects of other incorporated components (such as a binder, a conducting agent, etc.) can be achieved.

The D1/D ratio can be controlled by adjusting the amount of the positive electrode active material in the positive electrode active material layer 12.

The true density D of the positive electrode active material can be measured by the so-called Archimedes' method.

When the positive electrode active material particles are composed only of the positive electrode active material, the positive electrode active material particles are used as they are as a sample for measuring the true density D.

When the positive electrode active material particles are coated particles, the coating layer is removed to recover the core sections, and the recovered core sections (that is, the positive electrode active material) are used as a sample for measuring the true density D.

One example of the method for removing the coating layer of the coated particles when the coating layer is a layer of conductive carbon is a method that fires the coated particles. The conditions for firing the coated particles may be, for example, 800 to 900° C. for 3 hours or more.

One example of the method for taking out the positive electrode active material from the positive electrode active material layer 12 is a method that washes the positive electrode active material layer 12 with a solvent such as N-methylpyrrolidone (NMP) and, then, fires the positive electrode active material layer 12 in the presence of oxygen. This method enables the positive electrode active material to be recovered while removing an organic materials such as a binder, a conducting agent, and the like. The conditions for firing the positive electrode active material layer 12 may be, for example, 800 to 900° C. for 3 hours or more.

Examples of the method for measuring the true density D include a He gas replacement method and the like. In the He gas replacement method, for example, a dry densitometer Accupic II 1340 manufactured by Micromeritics (low volume expansion method; for example, sample amount 0.2 cm³ or more for the 10 cm³ type) can be used.

As an example of the measurement results of the true density D, when several grams of LiFePO₄ obtained by firing the positive electrode active material layer 12 was collected in a 10 cm³ cell, and the measurement was repeated five times to obtain an average value, the obtained value was 3.55 g/cm³. When the true density of LiCoO₂ was likewise measured, the obtained value was 5.0 g/cm³.

Further, if the positive electrode active material can be identified from the charge/discharge potential, the battery capacity, and the composition analysis by ICP, the true density peculiar to the crystal material can be obtained based on the literature values or the measurement results of the same material prepared in the same manner.

The literature value for LiFePO₄ is 3.6 g/cm³, which almost coincides with the above test result.

The true density D1 of the positive electrode active material layer 12 can also be determined by the He gas replacement method as in the case of the true density D. First, the true density D2 of the positive electrode 1 is measured with the positive electrode current collector 11 included. Next, the true density D1 is calculated from the value of the true density D2 in consideration of the thickness and the mass of the positive electrode current collector 11.

When calculating the true density D1, the true density D1 of only the positive electrode active material layer 12 can be obtained by measuring the thickness and mass of the positive electrode current collector 11 and subtracting the obtained values from the volume and mass of the positive electrode 1. That is, the true density D1 is calculated from the true density D2 on the assumption that no voids exist in the positive electrode current collector. The true density D1 may be determined by detaching the positive electrode active material layer 12 from the positive electrode current collector 11 and measuring the true density of the detached positive electrode active material layer 12. However, an error occurs in this method if deposits remain on the positive electrode current collector 11. Therefore, as a method for determining the true density D1, it is preferable to adopt a method that measures the true density D2 of the positive electrode 1 with the positive electrode current collector 11 included, and calculates the true density D1 from the true density D2.

D1 is preferably 3.4 g/cm³ or more and less than 3.6 g/cm³, more preferably 3.4 to less than 3.55 g/cm³, even more preferably 3.4 to less than 3.50 g/cm³.

In the present embodiment, the volume density of the positive electrode active material layer 12 is not particularly limited, and is preferably 2.05 to 2.80 g/cm³, more preferably 2.15 to 2.50 g/cm³.

The volume density of the positive electrode active material layer 12 can be measured by, for example, the following measuring method.

The thicknesses of the positive electrode 1 and the positive electrode current collector 11 are each measured with a micrometer, and the difference between these two thickness values is calculated as the thickness of the positive electrode active material layer 12. With respect to the thickness of the positive electrode 1 and the thickness of the positive electrode current collector 11, each of these thickness values is an average value of the thickness values measured at five or more arbitrarily chosen points which are sufficiently distant from each other. The thickness of the positive electrode current collector 11 may be measured at the exposed section 13 of the positive electrode current collector, which is described below.

The mass of the measurement sample punched out from the positive electrode so as to have a predetermined area is measured, from which the mass of the positive electrode current collector 11 measured in advance is subtracted to calculate the mass of the positive electrode active material layer 12.

The volume density of the positive electrode active material layer 12 is calculated by the following formula (1).

Volume density (unit: g/cm³)=mass of positive electrode active material layer (unit: g)/[thickness of positive electrode active material layer (unit: cm))×area of measurement sample (Unit: cm²)] (1)

When the volume density of the positive electrode active material layer 12 is within the above range, the volumetric energy density of the battery can be further improved, and a non-aqueous electrolyte secondary battery with a further improved cycle characteristics can be realized.

The volume density of the positive electrode active material layer 12 can be controlled by, for example, adjusting the amount of the positive electrode active material, the particle size of the positive electrode active material, the thickness of the positive electrode active material layer 12, and the like. When the positive electrode active material layer 12 contains a conducting agent, the volume density can also be controlled by selecting the type of the conducting agent (specific surface area, specific gravity), or adjusting the amount of the conducting agent, and the particle size of the conducting agent.

(Cycle Capacity Retention)

In the positive electrode 1 of the present embodiment, the cycle capacity retention determined by the following test method is preferably 80% or more, more preferably 85% or more, further preferably 90% or more, and may be 100%. When the cycle capacity retention is not less than the above lower limit, the high-rate cycling performance can be further enhanced.

(Test Method)

A non-aqueous electrolyte secondary battery is produced using the positive electrode so as to have a rated capacity of 1 Ah. The battery is subjected to 1000 repetitions of a charge/discharge cycle of charging at 3 C rate and 8 V, a 10-second pause, discharging at 3 C rate and 2.0 V, and a 10-second pause. Then, the battery is discharged at 0.2 C rate and 2.5 V to measure a discharge capacity B. The discharge capacity B is divided by a discharge capacity A of the battery before being subjected to the charge/discharge cycle to determine the cycle capacity retention (%).

<Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. Further, a separator 2 may be provided. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing such as an aluminum laminate bag, and a non-aqueous electrolyte (not shown) is injected into the outer casing, followed by sealing the outer casing.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are positioned so that the negative electrode 3 is located at the outermost layer.

(Negative Electrode)

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as graphite, graphene, hard carbon, Ketjen black, acetylene black, and carbon nanotube (CNT). With respect to each of the negative electrode active material and the conducting agent, a single type thereof may be used alone or two or more types thereof may be used in combination.

Examples of the material of the negative electrode current collector 31, the binder and the solvent in the negative electrode composition include those listed above as examples of the material of the positive electrode current collector 11, the binder and the solvent in the positive electrode composition. With respect to each of the binder and the solvent in the negative electrode composition, a single type thereof may be used alone or two or more types thereof may be used in combination.

The sum of the amount of the negative electrode active material and the amount of the conducting agent is preferably 80.0 to 99.9% by mass, and more preferably 85.0 to 98.0% by mass, based on the total mass of the negative electrode active material layer 32.

(Separator)

The separator 2 is disposed between the negative electrode 3 and the positive electrode 1 to prevent a short circuit or the like. The separator 2 may retain a nonaqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The separator 2 may contain various plasticizers, antioxidants, and flame retardants.

Examples of the antioxidant include phenolic antioxidants such as hindered-phenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

(Non-Aqueous Electrolyte)

The non-aqueous electrolyte fills the space between the positive electrode 1 and the negative electrode 3. For example, any of known non-aqueous electrolytes used in lithium ion secondary batteries, electric double layer capacitors and the like can be used.

As the non-aqueous electrolyte, a non-aqueous electrolyte solution in which an electrolyte salt is dissolved in an organic solvent is preferable.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte salt is not particularly limited, and examples thereof include lithium-containing salts such as LiClO₄, LiPF₆, LiBF₄, LiAsF₆, LiCF₆, LiCF₃CO₂, LiPF₆SO₃, LiN(SO₂F)₂, LiN(SO₂CF₃)₂, Li(SO₂CF₂CF₃)₂, LiN(COCF₃)₂, and LiN(COCF₂CF₃)₂, as well as mixture of two or more of these salts.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples which, however, should not be construed as limiting the present invention.

<Raw Materials Used>

(Positive Electrode Active Material Particles)
Coated particles of LiFePO₄: True density of core section (LiFePO₄) 3.55 g/cm³. The coating section is conductive carbon. The amounts of conductive carbon in the table are proportions relative to 100% by mass of the positive electrode active material particles.
LiCoO₂ (no coating section): True density 5.00 g/cm³.

(Conducting Agent)
Carbon black: True density 2.30 g/cm³.

(Binder)
Polyvinylidene fluoride (PVDF): True density 1.20 g/cm₃.

(Dispersant)
Polyvinylpyrrolidone (PVP): True density 1.78 g/cm³.

(Positive Electrode Current Collector)
A positive electrode current collector including current collector coating layers (thickness 2 μm) on both surfaces of an aluminum foil (thickness 15 μm). The current collector coating layer contains carbon black (100 parts by mass) and a binder (40 parts by mass).

### (Production Method)

A positive electrode current collector was prepared by coating both the front and back surfaces of a positive electrode current collector main body with current collector coating layers by the following method. An aluminum foil (thickness 15 μm) was used as the positive electrode current collector main body.

A slurry was obtained by mixing 100 parts by mass of carbon black, 40 parts by mass of polyvinylidene fluoride as a binder, and N-methylpyrrolidone (NMP) as a solvent. The amount of NMP used was the amount required for applying the slurry.

The obtained slurry was applied to both surfaces of the positive electrode current collector main body by a gravure method so as to allow the resulting coating films after drying to have a thickness of 2 μm (total for both surfaces), and dried to remove the solvent, thereby obtaining a positive electrode current collector. The current collector coating layers 15 on both surfaces were formed so as to have the same amount of coating and the same thickness.

<Measuring Method>

(Cycle Capacity Retention)

The cycle capacity retention was evaluated following the procedures (1) to (7) below.

(1) A non-aqueous electrolyte secondary battery (cell) was manufactured so as to have a rated capacity of 1 Ah, and a cycle evaluation was carried out at room temperature (25° C.).

(2) The obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA).

(3) The cell was discharged for capacity confirmation at a constant current rate of 0.2 C and with a cut-off voltage of 2.5 V. The discharge capacity at this time was set as the reference capacity, and the reference capacity was set as the current value at 1 C rate (that is, 1,000 mA).

(4) After charging the cell at a constant current at a cell's 3 C rate (that is, 3000 mA) and with a cut-off voltage of 3.8 V, a 10-second pause was provided. From this state, the cell was discharged at 3 C rate and with a cut-off voltage of 2.0 V, and a 10-second pause was provided.

(5) The cycle test of (4) was repeated 1,000 times.

(6) After performing the same charging as in (2), the same capacity confirmation as in (3) was performed.

(7) The discharge capacity in the capacity confirmation measured in (6) was divided by the reference capacity before the cycle test to obtain a capacity retention after 1.000 cycles in terms of percentage (1,000-cycle capacity retention, unit: %).

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed under a load of 2 kN to obtain a negative electrode sheet. The obtained negative electrode sheet was punched to obtain a negative electrode.

### Production Example 2: Production of Non-Aqueous Electrolyte Secondary Battery

A non-aqueous electrolyte secondary battery having a configuration shown in FIG. 2 was manufactured by the following method.

LiPF₆ as an electrolyte was dissolved at 1 mol/L in a solvent in which ethylene carbonate (EC) and diethyl carbonate (DEC) were mixed at a volume ratio, EC:DEC, of 3:7, to thereby prepare a non-aqueous electrolytic solution.

The positive electrode obtained in each of the Examples and the negative electrode obtained in Production Example 1 were alternately interleaved through a separator to prepare an electrode layered body with its outermost layer being the negative electrode. A polyolefin film (thickness 15 μm) was used as the separator.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a nonaqueous electrolyte secondary battery (laminate cell).

With respect to the obtained non-aqueous electrolyte secondary battery, the cycle capacity retention was measured.

### Examples 1 to 3, Comparative Examples 1 to 2

Based on the amounts shown in Table 1, the positive electrode active material particles, the conducting agent, the binder and the dispersant were dispersed in a solvent (NMP) to prepare a positive electrode composition. The amount of the solvent used was the amount required for applying the positive electrode composition. The blending amounts of the positive electrode active material particles, the conducting agent, the binder and the dispersant in the table are percentage values relative to the total 100% by mass excluding the solvent (that is, the total amount of the positive electrode active material particles, the conducting agent, the binder, and the dispersant). In the table, the amounts in each composition are in terms of % by mass of the material, and “-” indicates that the material was not used.

The positive electrode composition was applied to the positive electrode current collector, and after pre-drying, the applied composition was vacuum-dried at 120° C. to form a positive electrode active material layer. The coating volume of the positive electrode composition was 31 mg/cm².

The resulting laminate was pressure-pressed with a load of 10 kN to obtain a positive electrode sheet. The obtained positive electrode sheet was punched to obtain a positive electrode.

With respect to the positive electrode of each example, the true density D1 was determined.

A non-aqueous electrolyte secondary battery was produced using the positive electrode of each example, and the cycle capacity retention thereof was determined. The results are shown in Table 1.

TABLE 1

| | COMPOSITION | | | | | | | | |
|---|---|---|---|---|---|---|---|---|---|
| | POSITIVE ELECTRODE | | | | | | | | |
| | ACTIVE MATERIAL | | | | | | | | |
| | PARTICLES | | | | | | | | |
| | POSITIVE | | | | | | | | RESULT |
| | ELECTRODE | AMOUNT OF | | | | | TRUE | | CYCLE |
| | ACTIVE | CONDUCTIVE | | CONDUCTING | BINDER | DISPERSANT | DENSITY | D1/DR | CAPACITY |
| | MATERIAL | CARBON | AMOUNT | AGENT | PVDF | PVP | D1 | RATIO | RETENTION |
| Ex. 1 | LiFePO₄ | 1.2% | 99.5% | — | 0.5% | — | 3.48 g/cm³ | 97.9% | 90% |
| Ex. 2 | LiFePO₄ | 1.2% | 98.4% | 0.5% | 1.0% | 0.1% | 3.45 g/cm³ | 97.0% | 83% |
| Ex. 3 | LiCoO₂ | — | 98.8% | 0.2% | 1.0% | — | 4.93 g/cm³ | 98.6% | 82% |
| Comp. | LiFePO₄ | 1.2% | 93.3% | 5.0% | 1.5% | 0.2% | 3.36 g/cm³ | 94.7% | 68% |
| Ex. 1 | | | | | | | | | |
| Comp. | LiFePO₄ | 1.4% | 95.4% | 3.0% | 1.5% | 0.1% | 3.39 g/cm³ | 95.5% | 60% |
| Ex. 2 | | | | | | | | | |

As shown in Table 1, in Examples 1 to 3 to which the present invention was applied, the cycle capacity retention was 82% or more.

In Comparative Examples 1 and 2 in which the D1/D ratio was less than 96%, the cycle capacity retention was 68% or less.

From these results, it was confirmed that the present invention can improve the high rate cycling performance.

### REFERENCE SIGNS LIST

1 Positive electrode
2 Separator
3 Negative electrode
5 Outer casing
10 Secondary battery
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector

1. A positive electrode for a non-aqueous electrolyte secondary battery, comprising a positive electrode current collector having a positive electrode current collector main body which is a metal, and a positive electrode active material layer provided on the positive electrode current collector, wherein:
the positive electrode active material layer comprises one or more positive electrode active material particles comprising a positive electrode active material, and optionally a conducting agent;
the positive electrode active material is lithium iron phosphate represented by LiFePO₄;
an amount of the positive electrode active material particles is 95% by mass or more, based on a total mass of the positive electrode active material layer;
at least a part of the positive electrode active material particles have a core section formed of the positive electrode active material, and a coated section which covers the core section and includes a conductive material;
the positive electrode has a conductive carbon content of 0.5 to 3.5% by mass, with respect to a mass of the positive electrode excluding the positive electrode current collector main body; and
a true density D of the positive electrode active material and a true density D1 of the positive electrode active material layer satisfy formula (s):
0.96D≤D1<D (s).

2. (canceled)

3. (canceled)

4. The positive electrode according to claim 1, wherein the true density D1 is 3.4 g/cm³ or more and less than 3.6 g/cm³.

5. (canceled)

6. (canceled)

7. The positive electrode according to claim 1, which has a cycle capacity retention of 80% or more, as measured by a test method comprising: producing a nonaqueous electrolyte secondary battery using the positive electrode so as to have a rated capacity of 1 Ah; subjecting the battery to 1000 repetitions of a charge/discharge cycle of charging at 3 C rate and 8 V, a 10-second pause, discharging at 3 C rate and 2.0 V, and a 10-second pause; discharging the battery at 0.2 C rate and 2.5 V to measure a discharge capacity B; and dividing the discharge capacity B by a discharge capacity A of the battery before being subjected to the charge/discharge cycle to determine the cycle capacity retention (%).

8. A non-aqueous electrolyte secondary battery, comprising the positive electrode of claim 1, a negative electrode, and a non-aqueous electrolyte disposed between the positive electrode and the negative electrode.

9. A battery module or battery system comprising a plurality of the non-aqueous electrolyte secondary batteries of claim 8.
